(19) United States
(12) Patent Application Publication
(10) Pub. No.: US 2016/0196832 A1
(43) Pub. Date: Jul. 7, 2016

(54) SYSTEM ENABLING A PERSON TO SPEAK PRIVATELY IN A CONFINED SPACE

(71) Applicant: Gulfstream Aerospace Corporation, Savannah, GA (US)

(72) Inventors: John W. Maxon, Savannah, GA (US); John J. Neely III, Savannah, GA (US)

(21) Appl. No.: 14/590,685

(22) Filed: Jan. 6, 2015

(51) Int. Cl. G10L 21/00

(52) U.S. Cl. CPC G10L 21/00

(57) ABSTRACT

A system for enabling a person to speak privately in a confined space having a plurality of listening zones includes a sound-generating unit, a person-detecting unit configured to detect a first location of the person within the confined space and to generate a first signal containing information indicative of the first location, and a processor operatively coupled with the sound-generating unit and communicatively coupled with the person-detecting unit. The processor is configured to obtain the first signal from the person-detecting unit, to identify a first listening zone of the plurality of listening zones where the person is located based on the first signal, and to control the sound-generating unit to emit the sound into a second listening zone of the plurality of listening zones. The sound is configured to render a conversation had by the person in the first listening zone substantially inaudible from the second listening zone.

### TECHNICAL FIELD

The present invention generally relates to a system that enhances privacy and more particularly relates to system that enables a person to speak privately in a confined space having a plurality of listening zones.

### BACKGROUND

Modern passenger aircraft, and in particular, business jets have made substantial advances in noise mitigation as well as advances in the suppression of noise transmission. Advances in noise mitigation include reducing the magnitude of the sounds caused by operation of the jet engines and reducing the magnitude of the sounds caused by interaction between an aircraft's exterior surfaces and the surrounding atmosphere air during flight. Advances in the suppression of noise transmission include the extensive use of vibration isolators to inhibit the transmission of vibrations into the passenger cabin, the use of improved insulating blankets, and the use of improved mounting techniques to envelope the aircraft's cabin in a sound/vibration barrier. Thanks to these improvements, there is now less noise generated by the aircraft during flight and more protection against its intrusion into the cabin. This yields an aircraft cabin that is arguably as quiet as any ground based conference room and permits passengers to engage in conversations using normal speaking voices from opposite ends of the cabin.

One consequence of this successful campaign to provide passengers with a quiet cabin is that the level of background noise experienced on some aircraft during flight is so low that it is not possible to carry on a conversation without it being overheard. In instances where the subject matter of a conversation is private, sensitive or confidential, and where persons other than the conversation participants are present in the cabin, the conversation participants may find it undesirable to conduct that conversation out of a concern that it will be overheard.

Accordingly, it is desirable to provide a system that permits a person to speak privately in a confined space such as, but not limited to, an aircraft passenger compartment. Furthermore, other desirable features and characteristics will become apparent from the subsequent summary and detailed description and the appended claims, taken in conjunction with the accompanying drawings and the foregoing technical field and background.

### BRIEF SUMMARY

A system for enabling a person to speak privately in a confined space having a plurality of listening zones is disclosed herein.

In a first non-limiting embodiment, the system includes, but is not limited to, a sound-generating unit. The system further includes, but is not limited to, a person-detecting unit that is configured to detect a first location of the person within the confined space and to generate a first signal containing information indicative of the first location. The system still further includes a processor that is operatively coupled with the sound-generating unit and that is communicatively coupled with the person-detecting unit. The processor is configured to obtain the first signal from the person-detecting unit, to identify a first listening zone of the plurality of listening zones where the person is located based on the first signal, and to control the sound-generating unit to emit the sound into a second listening zone of the plurality of listening zones. The sound is configured to render a conversation had by the person in the first listening zone substantially inaudible from the second listening zone.

In another non-limiting embodiment, the system includes, but is not limited to a sound-generating unit. The system further includes, but is not limited to, a person-detecting unit configured to detect a first location of the person within the confined space and to generate a first signal containing information indicative of the first location. The system further includes an input unit configured to receive an input from the person and to generate a second signal containing information indicative of the input. The system still further includes, but is not limited to a processor that is operatively coupled with the sound-generating unit and that is communicatively coupled with the person-detecting unit and the input unit. The processor is configured to obtain the first signal from the person-detecting unit, to identify a first listening zone of the plurality of listening zones where the person is located based on the first signal, to obtain the second signal from the input unit, to determine that the person desires to conduct a private conversation based on the second signal, to control the sound-generating unit to emit the sound into a second listening zone of the plurality of listening zones in response to receiving the second signal. The sound is configured to render the private conversation in the first listening zone substantially inaudible from the second listening zone.

### BRIEF DESCRIPTION OF THE DRAWINGS

The present invention will hereinafter be described in conjunction with the following drawing figures, wherein like numerals denote like elements, and

FIG. 1 is a block diagram illustrating a non-limiting embodiment of a system for enabling a person to speak privately in a confined space having a plurality of listening zones;

FIG. 2 is a schematic overhead view illustrating a cabin of an aircraft equipped with an embodiment of the system illustrated in FIG. 1; and

FIG. 3 is a schematic cross sectional view taken along the line 3-3 of FIG. 2 illustrating another embodiment of the system illustrated in FIG. 1.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

An improved system for enabling a person to speak privately in a confined space is disclosed herein. The confined space, which may either be an open area or an area that is subdivided into separate compartments, may have any number of listening zones and any number of persons present within the confined space. In a non-limiting embodiment, the system includes a person-detecting unit for detecting the location of a person who desires to have a private conversation. That private conversation may be between that person and another person within the confined space or between that person and a remote listener (e.g., a phone call, a SKYPE messaging or video discussion, and the like).

The person-detecting unit may comprise any device or system suitable for detecting the presence of a person and his or her location within the confined space. A non-limiting example of a person-detecting unit may include a wireless receiver that is compatible for use with a remote control (a smart phone, a mobile device, a touch screen device associated with the confined space, and the like). The remote control may be configured to generate a signal corresponding to an input by the person seeking to initiate the private conversation. The wireless receiver may cooperate with a processor to detect the person's presence and location. Another non-limiting example of a person-detecting unit may include a microphone or a plurality of microphones configured to generate a signal(s) corresponding to a sound detected by the microphone(s). Another non-limiting example of a person-detecting unit may include a video camera or a plurality of video cameras configured to generate a signal corresponding to the video images captured by the video camera. Another non-limiting example of a person-detecting unit may include a motion detector or a plurality of motion detectors configured to generate a signal(s) corresponding to movement detected by the motion detector(s). Another non-limiting example of a person-detecting unit may include an infrared sensor or a plurality of infrared sensors configured to generate a signal corresponding to the infrared radiation detected by the infrared sensors. It should be understood by those of ordinary skill in the art that the above list is not exhaustive in nature and any other person-detecting unit configured to detect the presence and location of a person may be employed.

The system for enabling a person to speak privately in a confined space further includes a sound-generating unit or a plurality of sound-generating units. The sound-generating unit is configured to emit sound. The sound emitted by the sound-generating unit may include, but is not limited to white noise, pink noise, and sounds that are configured to diminish or cancel out other sounds. Each sound-generating unit may be associated with a respective listening zone and may be configured to direct sound into its respective listening zone.

The system for enabling a person to speak privately in a confined space further includes a processor that is communicatively coupled with the person-detecting unit and that is operatively coupled with the sound-generating unit. The processor may be configured to receive the signal from the person-detecting unit and to utilize the information in that signal to determine where the person is located within the confined space and to further determine that the person desires to initiate a private conversation. The processor may be configured to determine the person's location in any suitable manner including through the use of triangulation or comparison of relative signal strengths. The processor may also be programmed with the known location of surface mounted remote controls and may utilize such information to determine the location of the person. The processor may also be configured to interpret video imagery or detected infrared radiation, or the like. Additionally, the processor may be configured to determine that the person desires to initiate a private conversation based on the information included in the signal.

In some embodiments, once the processor determines the location of the person desiring to have a private conversation, the processor is configured to determine which listening zone that person is located in. The delineation of the listening zones may be determined in any suitable manner. In some embodiments, the listening zones may be determined based on the presence of the sound-generating unit. For example, in a confined space having an integrated audio entertainment system that includes multiple loudspeakers, each listening zone may correspond to each loudspeaker of the audio entertainment system, the number of listening zones being equal to the number of loudspeakers. In such an example, the processor's determination of which listening zone the person is located in may comprise determining which loudspeaker the person is closest to based on the person's location within the confined space. In other embodiments, the listening zones may be determined based on where persons are expected to be positioned. For example, in a business jet, each seat, couch, table, private compartment (e.g., the flight deck, the passenger cabin, a lavatory, the cargo bay, a stateroom, a galley, a communications center), and the like may be considered to be a distinct listening zone because that is where people are expected to be positioned while on the aircraft.

The processor may also be configured to determine that a person desires to initiate a private conversation based on the information included in the signal from the person-detecting unit. For example, the processor may interpret information in the signal that is indicative of certain predetermined motions, gesture, movements, words, statements or utterances as being a trigger and in response, the processor may initiate a private conversation mode. In some embodiments, when initiating the private conversation mode, the processor may be configured to issue commands to the sound-generating unit(s) to emit sound into listening zones other than the listening zone where the person is located. In some embodiments, the processor may be configured to determine where one or more unintended listeners are located based on the signal, to determine which listening zones such unintended listeners are located in, and to control a respective sound-generating unit to emit sounds in those other listening zones to inhibit such unintended listeners from hearing the private conversation.

A greater understanding of the system described above may be obtained through a review of the illustrations accompanying this application together with a review of the detailed description that follows.

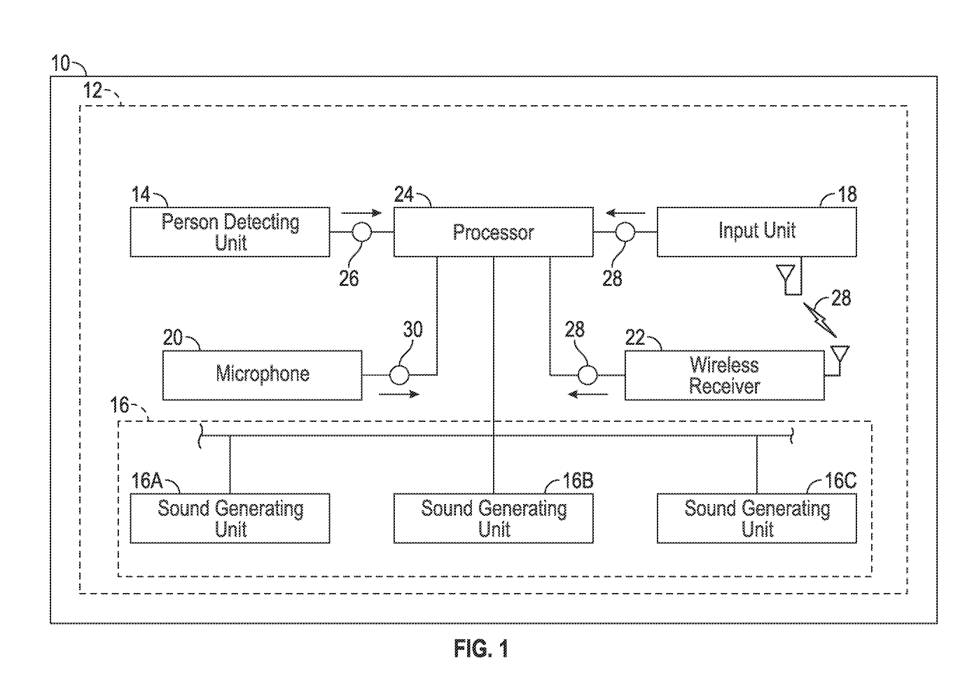

FIG. 1 is a block diagram illustrating a confined space 10 equipped with a non-limiting embodiment of a system 12 for enabling a person to speak privately in a confined space having a plurality of listening zones. In the illustrated embodiment, confined space 10 comprises a cabin of a business jet, but it should be understood that in other embodiments, confined space 10 may comprise the entire interior of the business jet including all compartments. In other embodiments, confined space 10 may comprise any enclosed area of any sort including, but not limited to, enclosed spaces within buildings, ground based vehicles, watercraft, aircraft, and spacecraft. In still other embodiments, system 12 may be compatible for use in confined spaces that are not completely enclosed without departing from the teachings of the present disclosure.

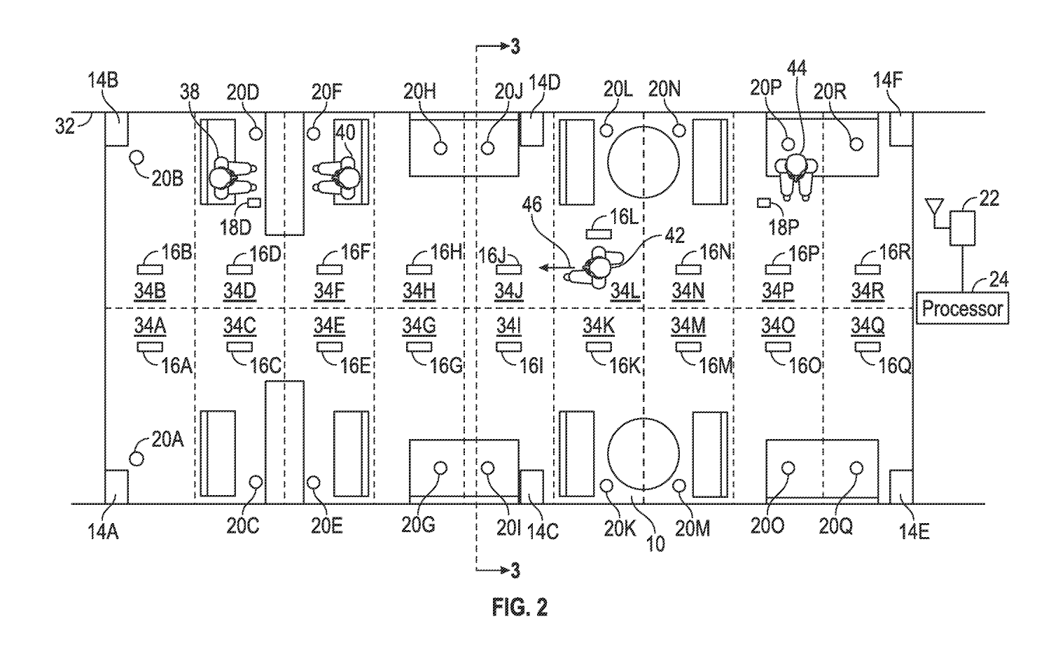

In the illustrated embodiment, system 12 includes a person-detecting unit 14, a plurality of sound-generating units 16, an input unit 18, a microphone 20, a wireless receiver 22 and a processor 24. In other embodiments, system 12 may include a greater or smaller number of components without departing from the teachings of the present disclosure. For example, in the illustrated embodiment, plurality of sound-generating units 16 comprises sound-generating units 16A through sound-generating unit 16R (see FIG. 2). In other embodiments plurality of sound-generating units 16 may include additional or fewer sound-generating units. Similarly, other embodiments of system 12 may include additional person-detecting units 14, additional input units 18, additional microphones 20 and additional wireless receivers 22. In still other embodiments, system 12 may have a single sound-generating unit, such as sound-generating unit 16A, or it may have no input unit 18, no microphone 20, and no wireless receiver 22, yet still fall within the scope of the present disclosure. The addition and/or combination of other types of components may also be possible while remaining within the scope of the present disclosure.

Person-detecting unit 14 may comprise any device, machine, or component capable of detecting the presence and location of a person. For example, a wireless receiver, such as wireless receiver 22 may serve as person-detecting unit 14 because wireless receivers are capable of detecting electromagnetic radiation radiating from a smart phone or a remote control which may be used by the person to initiate a private conversation. The radiation of such electromagnetic energy may actively or passively include information indicative of the presence and location of person. For example, a smart phone may be equipped with an application that is configured to interact with system 12 and to wirelessly transmit a signal indicative of its location in response to actuation by a person seeking to initiate a private conversation. A microphone or a plurality of microphones may also serve as person-detecting unit 14 because microphones are capable of detecting the presence and location of a person through the detection of audible sounds emanating from the person. A video camera or a plurality of video cameras may also serve as person-detecting unit 14 because video cameras are capable of detecting the presence and location of a person through the detection of visible light reflecting off of the person. A motion detector may also serve as person-detecting unit 14 because motion detectors are capable of detecting the presence and location of a person through detection of ultrasonic sounds reflecting off of the person. An infrared sensor may also serve as person-detecting unit 14 because infrared sensors are capable detecting the presence and location of a person through the detection of infrared radiation emanating from the person. Other types of detectors may also be employed as person-detecting unit 14 without departing from the teachings of the present disclosure.

Person-detecting unit 14 is configured to generate a signal 26 that includes information indicative of both the presence and the location of a person desiring to have a private conversation. In some non-limiting embodiments, signal 26 may also include information indicative of both the presence and the location of all persons within the confined space. As discussed below, person-detecting unit 14 is configured to provide signal 26 to processor 24.

Plurality of sound-generating units 16 may comprise any machine, device or unit configured to generate and project audible sound into a listening zone. In an embodiment, plurality of sound-generating units 16 may comprise loudspeakers such as the loudspeakers conventionally employed by audio or multimedia entertainment systems. When loudspeakers are utilized with system 12, they may be shared with a conventional audio or multimedia entertainment system or, in other embodiments, they may be dedicated for use exclusively with system 12. In other embodiments, plurality of sound-generating units 16 may comprise piezo-electric actuators. In an embodiment, a plurality of piezo-electric actuators may be mounted to a corresponding plurality of acoustic panels used to provide sound insulation to confined space 10. In other embodiments, plurality of sound-generating units 16 may comprise combinations of loudspeakers and piezo-electric actuators, while in still other embodiments, any other device suitable for generating and projecting sound may be utilized as plurality of sound-generating units 16. In some non-limiting embodiments, plurality of sound-generating units 16 may be configured to emit white noise, pink noise, a noise that camouflages the sounds of the private conversation, a noise that cancels out the sounds of the private conversation or any other type of noise that masks the private conversation.

Input unit 18 may comprise any electronic device or machine that is configured to permit the person desiring to have the private conversation to signal his or her desire to initiate the private conversation. For example, and without limitation, input unit 18 may comprise a switch, a wireless remote control, a mobile device configured for wireless communication, a smart phone, a control panel mounted to a surface or structure within the confined space, a keyboard, a mouse, a touch screen, a tablet and stylus, a button, a knob, a microphone, a camera, a motion detector, or any other device that is configured to permit a human to provide inputs into an electronic system. Input unit 18 may be configured to convert an input provided by the person desiring to have the private conversation into a signal 28. Signal 28 may be an electronic signal that is configured for transmission along a wired circuit. Alternatively, signal 28 may be an electronic signal configured for wireless transmission via any suitable electromagnetic means. Alternatively, signal 28 may be any other type of signal suitable for wireless transmission. In one example where input unit 18 comprises a smart phone, input unit 18 may be configured to communicate its present location, to trigger system 12 to initiate the private conversation, and to designate which listening zones should receive the masking noise from plurality of sound-generating units 16. In some embodiments, input unit 18 may be dedicated for use exclusively with system 12 while in other embodiments input unit 18 may be shared with other systems associated with confined space 10.

Microphone 20 may comprise any machine or device configured to receive and detect sound energy, to convert the sound energy to a signal 30, and to transmit signal 30 electronically or wirelessly to another component. Microphone 20 may also be configured to include in signal 30 information that is indicative of the magnitude of the sound energy received by microphone 20.

Wireless receiver 22 may comprise any device or machine suitable for receiving wireless communications. Wireless receiver 22 may be configured to receive electromagnetic signals, ultrasonic signals, infrared signals or any other type of wireless signal. In one example, wireless receiver 22 may be configured to receive signals from a smart phone, a mobile device, or a remote control. As illustrated in FIG. 1, wireless receiver 22 is configured to receive signal 28 wirelessly from input unit 18 and is further configured to forward signal 28 to processor 24. Although wireless receiver 22 is illustrated as comprising a separate and distinct component in FIG. 1, in other embodiments, wireless receiver 22 may be integrated into processor 24.

Processor 24 may be any type of computer, controller, micro-controller, circuitry, chipset, computer system, or microprocessor that is configured to perform algorithms, to execute software applications, to execute sub-routines and/or to be loaded with and to execute any other type of computer program. Processor 24 may comprise a single processor or a plurality of processors acting in concert. In some embodiments, processor 24 may be dedicated for use exclusively with system 12 while in other embodiments processor 24 may be shared with other systems associated with confined space 10.

Processor 24 is communicatively coupled to person-detecting unit 14, to input unit 18, to microphone 20 and to wireless receiver 22 and is operatively coupled with plurality of sound-generating units 16. Such couplings may be accomplished through the use of any suitable means of transmission including both wired and wireless connections. For example, each component may be physically connected to processor 24 via a coaxial cable or via any other type of wire connection effective to convey signals. In the embodiment illustrated in FIG. 1, processor 24 is directly communicatively connected to each of the other components. In other embodiments, each component may be communicatively connected to processor 24 across a communications bus. In still other examples, each component may be wirelessly connected to processor 24 via a Bluetooth connection, a WiFi connection or the like.

Being communicatively and operatively coupled provides a pathway for the transmission of commands, instructions, interrogations and other signals between processor 24 and each of the other components. Through this coupling, processor 24 may control and/or communicate with each of the other components. Each of the other components discussed above is configured to interface and engage with processor 24. For example, each sound-generating unit of plurality of sound-generating units 16 is configured to receive commands from processor 24 and to emit audible sounds in response to such commands. Similarly, in some non-limiting embodiments, person-detecting unit 14 may be configured to automatically provide signal 26 to processor 24 at periodic or regular intervals while in other non-limiting embodiments, person-detecting unit 14 may be configured to provide signal 26 to processor 24 in response to an interrogation received from processor 24 while in still other non-limiting embodiments, person-detecting unit 14 may be configured to provide signal 26 to processor 24 substantially continuously. In some embodiments, wireless receiver 22 may be configured to receive wireless communications from input unit 18 and to forward such wireless communications to processor 24 when received. Correspondingly, input unit 18 may be configured to convert operator actuations and/or movements into electronic signals and to communicate such signals directly to processor 24 or indirectly to processor 24 via wireless receiver 22. Microphone 20 may be configured to automatically provide a signal to processor 24 in response to detecting sound energy. In still other embodiments, each of the components may be further configured to interact with, and to communicate with, one or more of the other components of system 12 in addition to processor 24.

Processor 24 is configured to interact with, coordinate and/or orchestrate the activities of each of the other components of system 12 for the purpose of enabling a person to have a private conversation in a confined space having a plurality of listening zones, some or all of which may have an unintended listener. In a non-limiting embodiment, processor 24 may be programmed and/or otherwise configured to receive signal 26 from person-detecting unit 14. Processor 24 is configured to interpret the information included in signal 26 and to determine the location within confined space 10 where the person desiring to have the private conversation is positioned. For example, in an embodiment that employs a wireless receiver to serve as person-detecting unit 14, processor 24 may be configured to parse the information contained in signal 26 to determine which compartment within the confined space the person may be located or, in embodiments where the confined space is not sub-divided into separate compartments, the processor may be configured to determine the precise location of the person within confined space 10. The information may include precise location information or processor 24 may be configured to calculate the precise location based on triangulation techniques, comparison/assessment of signal strength, or by any other suitable method. In embodiments that employ microphones as person-detecting units 14, processor 24 may be configured to calculate the precise location based on signal strength and the directional magnitude of the signal. In embodiments that employ a video camera(s) as person-detecting unit 14, processor 24 may be configured to interpret the visual images captured by the video camera(s). Processor 24 may be configured to determine the location of the person using the sensor data provided by infrared sensors in embodiments that utilize infrared sensors as person-detecting unit 14. Any other technique suitable for determining the location of the person within the confined space may alternatively be employed without departing from the teachings of the present disclosure. In embodiments where signal 26 includes information about all persons present in the confined space, processor 24 may be configured to utilize that information to determine the presence and location of all persons present within the confined space.

As illustrated in FIG. 2, below, confined space 10 may be divided into a plurality of listening zones. In some embodiments, the number of listening zones may correspond in number with the number of sound-generating units (e.g., on a 1:1 basis). Processor 24 is configured to use the location of the person seeking to have the private conversation to determine which listening zone that person is located in. In some embodiments, processor 24 will know the location of each sound-generating unit of plurality of sound-generating units 16 and will determine that the person is located in a particular zone based on the person's proximity to one or more sound-generating units. In embodiments where processor 24 has determined the presence and locations of all persons within confined space 10, processor 24 may be further configured to determine which listening zones are occupied by which of the persons detected.

Processor 24 may also be configured to determine that the person wants to initiate the private conversation based on the information included in signal 26. For example, and without limitation, signal 26 may include information indicative of an initiation code in instances where the person uses a smart phone or remote control to communicate his or her intent to speak privately. In other instances, signal 26 may include information indicative of the utterance of a trigger word by the person seeking to have the private conversation or information indicative of the occurrence of a trigger motion/movement/gesture of the person. In such embodiments, processor 24 may be configured to use such information to discern who is the person seeking to have the private conversation and who are the unintended listeners.

In embodiments of system 12 equipped with input unit 18, a person may initiate a private conversation by transmitting signal 28 to processor 24. As illustrated, signal 28 may be delivered either via a wired connection (e.g. a wall or surface mounted control panel or touch screen controller) or via a wireless connection (e.g., a smart phone, a mobile device). In such embodiments, processor 24 is configured to determine which person in confined space 10 seeks to initiate the private conversation, where that person is located, and in which listening zone that person is positioned based on the information contained in signal 28. In some embodiments, input unit 18 may be configured to enable the person to designate which listening zones are occupied by the person or persons engaging in the private conversation and may be further configured to enable the person to designate which listening zone(s) should receive the masking sound.

In the illustrated embodiment, once processor 24 has determined the number and location of all persons located within confined space 10, which listening zones are occupied, and which person desires to initiate a private conversation, processor 24 is configured to send instructions to plurality of sound-generating units 16 to emit a masking sound. In some embodiments, processor 24 may be configured to control plurality of sound-generating units 16 in a manner that causes them to emit masking sounds into all listening zones other than the listening zone in which the person desiring to have the private conversation is located. In other embodiments, processor 24 may be configured to control plurality of sound-generating units 16 in a manner that cause only a portion of the sound-generating units to emit sounds into the listening zones that processor 24 has determined are occupied by unintended listeners. In still other embodiments, processor 24 may be configured to control plurality of sound-generating units 16 in a manner that causes one or more of the sound-generating units to emit sounds into listening zones that are located between the person desiring to have the private conversation and any/all unintended listeners to form a curtain of masking sound.

The sound emitted by plurality of sound-generating units 16 may be any noise suitable to allow the private conversation to remain private between only the participants. In some embodiments, the sound may comprise a white noise, a pink noise, or any other noise suitable for masking the private conversation. In some embodiments, rather than rendering the conversation inaudible, the noise may render the conversation indiscernible. For example, the conversation may be camouflaged by broadcasting the private conversation in a manner that is out of phase with the private conversation as it occurs to create interference between the speakers' voices and the broadcasted voices. In other examples, the voices of the participants in the private conversation may be recorded, jumbled, and then broadcast in a manner that overlays the private conversation to render the private conversation indistinguishable from the cacophony of sound the unintended listener is exposed to.

Some non-limiting embodiments may be equipped with microphone 20, or with a plurality of microphones 20. Microphone 20 is configured to detect the sounds of the private conversation and to transmit signal 30 to processor 24. Signal 30 contains information indicative of the sounds of the private conversation. Processor 24 is configured to receive signal 30 and to interpret the information contained in signal 30 to determine, among other things, the volume at which the private conversation is being conducted. Processor 24 is further configured to send additional instructions to plurality of sound-generating units 16 to adjust the volume of the sounds emitted by plurality of sound-generating units 16 to correspond with the volume at which the private conversation is occurring. Processor 24 may be configured to periodically or continuously receive signal 30 and to periodically or continuously determine when and by what amount the volume of the private conversation changes and to correspondingly send further instructions to plurality of sound-generating units 16 to adjust the volume of the sounds emitted by plurality of sound-generating units 16 to correspond with the volume of the private conversation as that volume changes. In other embodiments, a sound cancellation protocol may be employed to cancel the private conversation before it can reach the unintended listeners.

In some embodiments, processor 24 may be configured to utilize the information provided in signal 30 to control plurality of sound-generating units 16 in a manner that cancels the sounds of the private conversation. In such embodiments, rather than hearing the sound of a masking noise, the unintended listeners may hear nothing at all. In such embodiments, the unintended listeners may not even be aware that there is a private conversation occurring elsewhere in the confined space.

In some embodiments, person-detecting unit 14 may be configured to periodically or continually sense for and detect the presence of persons within the confined space. Person-detecting unit 14 may be further configured to transmit signal 26 in a correspondingly periodic or continuous manner In such embodiments, processor 24 may be configured to re-determine the location of unintended listeners. In this manner, processor 24 may determine whether the unintended listeners are remaining still during the private conversation or whether the unintended listeners have moved or are moving about confined space 10. When processor 24 determines that the unintended listeners have remained still during the private conversation, processor 24 will not alter the instructions provided to plurality of sound-generating units 16. In instances where processor 24 determines that one or more unintended listeners has moved about confined space 10, and further, where processor 24 has determined that one or more of such unintended listeners has moved from one listening zone to another listening zone, processor 24 may provide new instructions to plurality of sound-generating units 16. The new instructions may cause the sound-generating unit associated with the vacated listening zone to cease emitting sounds and to cause sound-generating units associated with the newly occupied listening zone to begin emitting sounds to mask the private conversation. In this manner, a person may conduct a private conversation that remains inaudible to unintended listeners who move about confined space 10 during the private conversation. Advantageously, unintended listeners need not remain stationary during a private conversation but instead, may move freely about confined space 10 during such private conversations.

System 12 may be operated in two alternate modes. In a first mode (referred to herein as the “monitoring mode”), system 12 may monitor confined space 10 with person-detecting unit 14 and await the occurrence of a triggering event. As discussed above, the triggering event may comprise the utterance of one or more predetermined phrases or it may comprise predetermined hand gestures or other predetermined movements or it may comprise receiving an actuating input at input unit 18.

When the triggering event is detected/received by system 12, system 12 will enter a second mode. In the second mode (referred to herein as the “privacy mode”), system 12 facilitates a person's ability to conduct a private conversation in confined space 10 despite the presence of other persons within confined space 10. It does so by utilizing plurality of sound-generating units 16 to emit masking sounds into listening zones occupied by unintended listeners, or in some embodiments, emitting sounds into all listening zones other than the listening zones occupied by the person or persons participating in the private conversation. System 12 may be configured to remain in privacy mode for a predetermined period of time, or until a second triggering event occurs that returns system 12 to monitoring mode. Such a second triggering event may be the utterance of a phrase, a gesture, a movement, the actuation of a switch on an input unit, or the like.

FIG. 2 is a schematic view illustrating a non-limiting embodiment of confined space 10. In the illustrated embodiment, confined space 10 comprises a passenger cabin of an aircraft 32. It should be understood that in other embodiments, the confined space may not be limited to the passenger cabin of aircraft 32, but may include the entire interior of aircraft 32, including its various compartments. In the illustrated embodiment, confined space 10 includes eighteen listening zones 34A; 34B; 34C; . . . 34Q; and 34R (collectively 34). Each listening zone includes a corresponding sound-generating unit 16 (16A; 16B; 16C; . . . 16Q; and 16R) and a corresponding microphone 20 (20A; 20B; 20C; . . . 20Q; and 20R). Several person-detecting units 14 (14A; 14B; 14C; 14D; 14E; and 14F) are distributed throughout confined space 10. A couple of input units 18 (18D; and 18P) are located throughout confined space 10. In addition, several persons are illustrated in confined space 10, including person 38, person 40, person 42, and person 44. In the illustrated embodiment, processor 24 and wireless receiver 22 are located outside of confined space 10, but it should be understood that in other embodiments, processor 24 and wireless receiver 22 may be located within confined space 10.

With continuing reference to FIGS. 1 and 2, two different scenarios involving private conversations within confined space 10 will now be discussed.

In a first scenario, system 12 is in the monitoring mode and person 38 desires to have a private conversation with person 40. To initiate the private conversation, person 38 and person 40 may each engage in conduct intended to be detected and interpreted by system 12 as an act that initiates privacy mode. Person 38 and person 40 may each utter a trigger phrase. For example, person 38 and person 40 may each audibly recite the phrase “initiate privacy mode” or “quiet please”.

The phrase may be detected by person-detecting unit 14B. Person-detecting unit 14B may then send signal 26 to processor 24. Signal 26 includes information that is indicative of the phrase uttered by person 38 and by person 40. Processor 24 is configured to utilize the information included in signal 26 to determine where person 38 is located within confined space 10 and where person 40 is located within confined space 10. Processor 24 is also configured to determine that person 38 is situated in listening zone 34D, that person 40 is situated in listening zone F based on the information included in signal 26. Processor 24 is also configured to determine that person 38 and person 40 want to have a private conversation and are requesting initiation of privacy mode based on the information included in signal 26.

Processor 24 may receive several signals 26, one from each person-detecting unit in confined space 10. For example, processor 24 may receive signals 26 from person-detecting units 14A, 14C, 14D, 14E, and 14F. The confluence of each signal 26 may enable processor 24 to determine the location of persons 42 and 44, and to determine that person 42 and person 44 are situated within listening zones 34L and 34P, respectively. In other embodiments, processor 24 may be configured to determine this information from the signal 26 provided by person-detecting unit 14B.

After receiving signal(s) 26 and after evaluating the information included with the signal, system 12 determines that person 38 and 40 desire to have a private conversation. Accordingly, system 12 enters the privacy mode. Processor 24 sends instructions to sound-generating units 16L and 16P that control them to emit white noise to mask the private conversation between person 38 and person 40. In this scenario, sound-generating units 16L and 16P are both loudspeakers integrated into confined space 10 and are part of the entertainment system of aircraft 32. Microphone 20D and microphone 20F detect the private conversation between person 38 and person 40 and send signals 30 to processor 24 including information indicative of the volume of the conversation. Processor 24 utilizes this information to provide further instructions to sound-generating units 16L and 16P that raises or lowers the volume of the white noise as needed to more effectively and more efficiently mask the private conversation.

While system 12 is in privacy mode, person 42 is moving about confined space 10 in the direction indicated by arrow 46. As person 42 moves in that direction, he will exit listening zone 34L and will enter listening zone 34J. Person-detecting units 14A-14F are configured to continuously monitor to detect the presence of persons within confined space 10 and continuously provide an updated signal 26 to processor 24. Processor 24 is configured to detect the changing location of person 42 and to continuously assess which listening zone person 42 is situated in. Processor 24 is further configured to determine when person 42 exits listening zone 34L and enters listening zone 34J, and to instruct sound-generating unit 16L to discontinue its emission of white noise when person 42 exits listening zone 34L and to instruct sound-generating unit 16J to commence emitting white noise when person 42 enters listening zone 34J.

When person 38 and person 40 are finished speaking in private, person 38 and person 40 may each engage in predetermined conduct that communicates to system 12 that they wish to discontinue privacy mode. Each may utter a predetermined phrase or each may make a predetermined gesture, or the like. Upon detection of the conduct, system 12 may return to privacy mode.

In a second scenario, person 38 again desires to have a private conversation with person 40. In this scenario, person 38 utilizes input unit 18D to communicate his desire to put system 12 into privacy mode. Input unit 18D is a smart phone loaded with an application that permits person 38 to interact with system 12. Using input unit 18D, person 38 communicates his desire to put system 12 into privacy mode, and may further designate which listening zones that system 12 should mask with noise. Input unit 18D may include a touch screen read out that identifies the distinct listening zones to facilitate selection by person 38.

Upon actuation, input unit 18D will transmit a wireless signal 28 to wireless receiver 22. In this scenario, wireless receiver 22 serves as person-detecting unit 14. Wireless receiver 22 receives signal 28 from input unit 18D and forwards signal 28 to processor 24. In response to signal 28, processor 24 discerns which listening zones 34 have unintended listeners within them and, consequently, which sound-generating units to send instructions to to emit a masking noise.

Input unit 18D may be configured to permit person 38 to add or delete listening zones that need masking. In this manner, person 38 can turn the white noise on and off in specified listening zones to accommodate unintended listeners who are moving throughout confined space 10. Input unit 18D may be further configured to permit person 38 to cause system 12 to exit privacy mode and to return to monitoring mode.

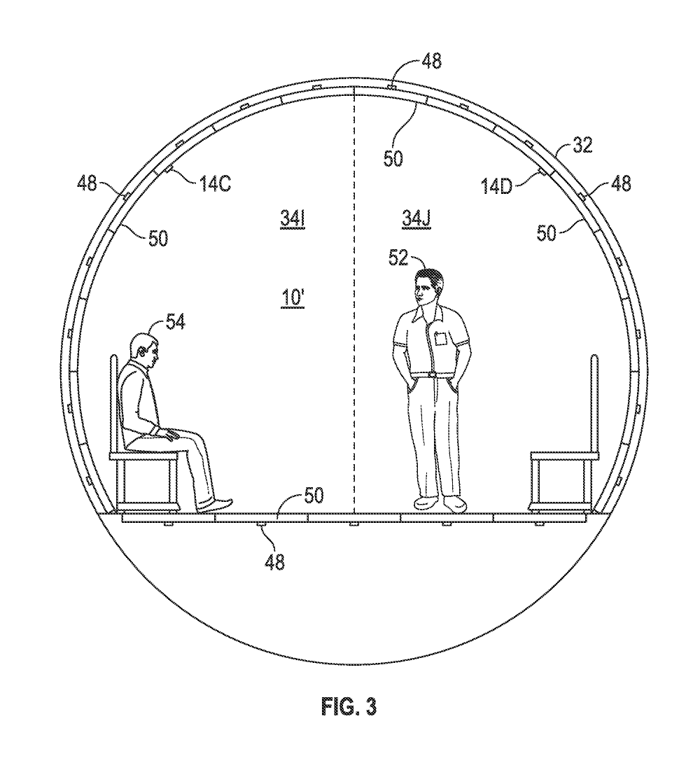

With continuing reference to FIGS. 1-2, FIG. 3 is a cross-sectional view illustrating a cross section of aircraft 32 taken along line 3-3 of FIG. 2. Aircraft 32 of FIG. 3 is equipped with an alternate embodiment 10′ of a confined space having a plurality of listening zones. Whereas confined space 10 of FIG. 2 utilized loudspeakers of the entertainment system of aircraft 32, alternate embodiment 10′ utilizes piezo-electric actuators 48 mounted to acoustic panels 50 which surround an interior space of the confined space of embodiment 10′. Piezo-electric actuators 48, when actuated, will transmit a vibration into the acoustic panel 50 to which it is mounted. That acoustic panel 50 will begin to vibrate and will behave like a loudspeaker and, as a result, will emit a sound into the interior of embodiment 10′.

As illustrated, listening zones 341 and 34J are each bordered by several piezo-electric actuators 48 and acoustic panels 50. This permits system 12 to more precisely target the unintended listeners within a particular listening zone. For example, a person 52 is standing in listening zone 34J while a person 54 is seated in listening zone 341. System 12 may be configured to determine the location of a person's ears (e.g., if a video camera or an infrared sensor serves as person-detecting unit 14) and to control the piezo-electric actuators 48 closest to that person's ears. Accordingly, processor 24 may control the piezo-electric actuators 48 in the upper region of listening zone 34 J to vibrate and emit sounds while leaving those actuators in the lower region of listening zone 34 deactivated. In listening zone 341, where person 54 is seated, a different strategy may be employed. Rather than actuating the piezo-electric actuators 48 in the upper region of listening zone 341, processor 24 would instead actuate the piezo-electric actuators 48 in the mid and lower regions of listening zone 341. In this manner, the use of piezo-electric actuators 48 with system 12 permits system 12 to more precisely target the ears of an unintended listener(s) to effectively and efficiently mask the private conversation.

In embodiments where the confined space is subdivided into discrete compartments, the listening zones may be delineated in a manner that corresponds with the discrete compartments. In such embodiments, the system may be configured to cause the sound generating units to emit sound in the compartments other than the compartment where the person is located or in other compartments where unintended listeners may be located. In still other embodiments, the system may be configured to cause the sound generating units to emit sound both within the compartment where the person is located and also in other compartments to provide the person with privacy.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the disclosure as set forth in the appended claims.

What is claimed is:

1. A system for enabling a person to speak privately in a confined space having a plurality of listening zones, the system comprising:
a sound-generating unit;
a person-detecting unit configured to detect a first location of the person within the confined space and to generate a first signal containing information indicative of the first location; and
a processor operatively coupled with the sound-generating unit and communicatively coupled with the person-detecting unit, the processor configured to:
obtain the first signal from the person-detecting unit,
identify a first listening zone of the plurality of listening zones where the person is located based on the first signal, and
control the sound-generating unit to emit a sound into a second listening zone of the plurality of listening zones, the sound configured to render a conversation had by the person in the first listening zone substantially inaudible from the second listening zone.

2. The system of claim 1, wherein the person-detecting unit is further configured to detect a second location of an unintended listener within the confined space and to include information indicative of the second location in the first signal, and wherein the processor is further configured to identify the second listening zone based on the second location.

3. The system of claim 2, wherein the second listening zone and the second location substantially coincide.

4. The system of claim 2, wherein the second listening zone is disposed between the first listening zone and the second location.

5. The system of claim 2, further comprising a plurality of the sound-generating units, each sound-generating unit of the plurality of the sound-generating units configured to emit the sound into a respective listening zone of the plurality of listening zones, wherein the person-detecting unit is further configured to at least periodically detect the second location of the unintended listener within the confined space and to at least periodically update the information indicative of the second location in the first signal, and wherein the processor is further configured to at least periodically obtain the first signal from the person-detecting unit, to identify a new second listening zone when the second location changes, and to control a second sound-generating unit of the plurality of the sound-generating units to emit the sound into the new second listening zone, wherein the conversation will remain substantially inaudible to the unintended listener as the unintended listener moves about the confined space.

6. The system of claim 1, further comprising a plurality of the sound-generating units corresponding in number to the plurality of listening zones, each sound-generating unit of the plurality of the sound-generating units configured to emit the sound into a respective listening zone of the plurality of listening zones, wherein the processor is further configured to control the plurality of the sound-generating units to emit the sound into all listening zones other than the first listening zone.

7. The system of claim 1, further comprising a plurality of the sound-generating units corresponding in number to the plurality of listening zones, each sound-generating unit of the plurality of the sound-generating units configured to emit the sound into a respective listening zone of the plurality of listening zones, and wherein each sound-generating unit comprises a loudspeaker.

8. The system of claim 1, further comprising a plurality of the sound-generating units corresponding in number to the plurality of listening zones, each sound-generating unit of the plurality of the sound-generating units configured to emit the sound into a respective listening zone of the plurality of listening zones, and wherein each sound-generating unit comprises a piezo-electric actuator.

9. The system of claim 8, wherein the confined space comprises an aircraft passenger cabin, wherein the aircraft passenger cabin is substantially enveloped by a plurality of acoustic panels, and wherein each piezo-electric actuator is mounted to a respective acoustic panel of the plurality of acoustic panels.

10. The system of claim 1, wherein the person-detecting unit comprises at least one of a wireless receiver, a microphone, a video camera, motion detector, and an infrared sensor.

11. The system of claim 1, further comprising a microphone disposed within the confined space, the microphone configured to detect the conversation and to generate a second signal corresponding with the conversation, wherein the processor is communicatively coupled with the microphone and is further configured to obtain the second signal from the microphone, to determine a first volume of the conversation, and to control the sound-generating unit to emit the sound at a second volume corresponding with the first volume.

12. The system of claim 11, wherein the processor is further configured to periodically obtain the second signal from the microphone, to determine when a change occurs in the first volume, and to control the sound-generating unit to alter the second volume in a manner that corresponds with the change in the first volume.

13. The system of claim 1, wherein the sound comprises at least one of a white noise and a pink noise.

14. The system of claim 1, wherein the sound comprises a noise cancellation emission configured to cancel the conversation.

15. A system for enabling a person to speak privately in a confined space having a plurality of listening zones, the system comprising:
a sound-generating unit;
a person-detecting unit configured to detect a first location of the person within the confined space and to generate a first signal containing information indicative of the first location;
an input unit configured to receive an input from the person and to generate a second signal containing information indicative of the input; and
a processor operatively coupled with the sound-generating unit and communicatively coupled with the person-detecting unit and the input unit, the processor configured to:
obtain the first signal from the person-detecting unit,
identify a first listening zone of the plurality of listening zones where the person is located based on the first signal,
obtain the second signal from the input unit,
determine that the person desires to conduct a private conversation based on the second signal, and
control the sound-generating unit to emit a sound into a second listening zone of the plurality of listening zones in response to receiving the second signal, the sound configured to render the private conversation in the first listening zone substantially inaudible from the second listening zone.

16. The system of claim 15, wherein the input unit comprises a remote control associated with the confined space.

17. The system of claim 15, further comprising a wireless receiver communicatively coupled with the processor, wherein the input unit is configured to wirelessly transmit the second signal, wherein the wireless receiver is configured to receive the second signal and to convey the second signal to the processor.

18. The system of claim 17, wherein the input unit comprises a smart phone.

19. The system of claim 15, wherein the input unit is configured to enable the person to make a designation of the second listening zone and to include information indicative of the designation in the second signal, and wherein the processor is configured to identify the second listening zone based on the designation.

20. The system of claim 15, wherein the person-detecting unit is further configured to detect a second location of an unintended listener within the confined space and to include information indicative of the second location in the first signal, and wherein the processor is further configured to identify the second listening zone based on the second location.
